(19) United States
(12) Patent Application Publication
(10) Pub. No.: US 2026/0202851 A1
(43) Pub. Date: Jul. 16, 2026

(54) DETECTING AND TRACKING SAFETY PROJECTOR PATTERNS FOR EARLY COLLISION AVOIDANCE WITH OTHERWISE INVISIBLE NEARBY MOVING OBJECTS

(71) Applicant: ATLAS ROBOTICS AND AUTOMATION, INC., Pittsburgh, PA (US)

(72) Inventors: Çetin Alp Meriçli, Pittsburgh, PA (US); Tekin Alp Meriçli, Pittsburgh, PA (US)

(21) Appl. No.: 19/443,228

(22) Filed: Jan. 8, 2026

Related U.S. Application Data
(60) Provisional application No. 63/743,863, filed on Jan. 10, 2025.

(51) Int. Cl. G05D 1/633; G05D 1/242; G05D 1/247; G05D 101/15; G05D 107/70; G05D 111/10

(52) U.S. Cl. CPC G05D 1/633; G05D 1/242; G05D 1/247; G05D 2101/15; G05D 2107/70; G05D 2111/14

(57) ABSTRACT

A collision avoidance system for autonomous mobile robots detects safety projector patterns emitted by industrial vehicles to enable early detection before line-of-sight contact. The system comprises ground-facing cameras and LIDAR sensors monitoring ground surfaces for projected patterns. A pattern recognition module implements a Ground-Projector Detection Network with ground-plane homography estimation, perspective-adaptive feature extraction, and temporal aggregation to detect patterns under severe perspective distortion and partial occlusion. LIDAR ground surface detection generates binary masks that are iteratively refined based on pattern detection feedback, reducing false positives and improving computational efficiency. Pattern recognition distinguishes safety projector patterns from ground markings using domain-specific features and physics-based training. Vehicle localization estimates positions and trajectories with uncertainty quantification. The system provides advance warning enabling proactive collision avoidance, achieving SIL 2 safety integrity.

### CROSS-REFERENCE TO RELATED APPLICATIONS

This application claims priority to U.S. Provisional Patent Application No. 63/743,863, filed Jan. 10, 2025, entitled “DETECTING AND TRACKING SAFETY PROJECTOR PATTERNS FOR EARLY COLLISION AVOIDANCE WITH OTHERWISE INVISIBLE NEARBY MOVING OBJECTS,” the entire disclosure of which is incorporated herein by reference.

### TECHNICAL FIELD

This disclosure relates generally to autonomous vehicle safety systems and, more particularly, to systems and methods for detecting and tracking safety projector patterns emitted by industrial vehicles to enable early collision avoidance with vehicles that are not yet visible to line-of-sight sensors.

### BACKGROUND

### 1. Introduction to Industrial Vehicle Safety

Industrial environments such as warehouses, distribution centers, manufacturing facilities, and logistics hubs present unique challenges for vehicle safety. These environments typically involve the operation of multiple industrial vehicles including forklifts, pallet jacks, reach trucks, order pickers, and automated guided vehicles (AGVs) operating in close proximity within confined spaces. The simultaneous operation of both human-operated and autonomous vehicles in these environments creates complex safety challenges that traditional automotive safety systems are not that address.

According to OSHA statistics, forklift-related accidents result in approximately 85 fatalities and 34,900 serious injuries annually in the United States, with a considerable percentage occurring at blind intersections and aisles where visibility is limited. The emergence of autonomous mobile robots in warehouse environments introduces new collision scenarios involving human-operated forklifts and autonomous vehicles approaching from perpendicular aisles separated by high-density racking.

The density of vehicle traffic in modern warehouses has increased considerably with the rise of e-commerce and just-in-time manufacturing. According to industry statistics, warehouse traffic has increased by over 40% in the past decade, while the average aisle width has decreased to maximize storage density. This combination of increased traffic and reduced maneuvering space has led to a corresponding increase in vehicle-to-vehicle collision risks.

### 2. Conventional Safety Projector Systems

To address basic safety concerns, many modern industrial vehicles, particularly forklifts, are equipped with safety projector systems. These systems typically project visible light patterns onto the ground surface surrounding the vehicle to alert nearby personnel and other vehicle operators of the forklift's presence. Common projector patterns include:
Blue or red spot lights projected several feet ahead of the vehicle to warn pedestrians of approaching traffic
Directional arrows indicating the vehicle's intended direction of travel
Line patterns delineating the vehicle's travel path or safety zone
Flashing patterns providing enhanced visibility in high-traffic areas
Arc patterns indicating turning radius or lateral clearance requirements

These safety projectors serve primarily as warning devices for human personnel and operators of other vehicles. The projectors are particularly valuable when a forklift is approaching blind spots, corners, or intersections where visual line-of-sight is obstructed. In many facilities, the use of safety projectors has become a standard safety requirement, with some facilities mandating specific projector colors or patterns for different vehicle types or operational zones.

However, while these projector systems effectively warn human operators and pedestrians, current autonomous mobile robots and automated industrial vehicles do not utilize the information conveyed by these projected patterns. This represents a missed opportunity for enhanced safety and coordination in mixed autonomous-human vehicle environments.

### 3. Current Autonomous Vehicle Perception Systems

Autonomous mobile robots (AMRs) and automated guided vehicles (AGVs) deployed in industrial settings typically rely on a combination of sensors for environmental perception and collision avoidance.

### 3.1 Line-of-Sight Sensors

Most current systems employ line-of-sight sensors including LIDAR (Light Detection and Ranging) systems, stereo camera systems, monocular cameras with computer vision algorithms, ultrasonic sensors, and RADAR systems. These sensors can only detect objects that are within direct view, which becomes particularly problematic in warehouse environments characterized by high-density racking, narrow aisles, blind corners, and palletized loads that create visual obstructions.

Current line-of-sight-based obstacle detection systems can only detect obstacles within direct view, resulting in detection at the intersection itself with inadequate time for smooth collision avoidance. For vehicles approaching at typical warehouse speeds (1.5-2.5 m/s), line-of-sight detection provides only 0.5-1.5 seconds of advance warning, necessitating abrupt emergency braking that can destabilize loads and reduce operational efficiency.

Industry safety standards including ISO 3691-4 (Safety of driverless industrial trucks) require obstacle detection systems to provide adequate warning distance to enable safe stopping. For autonomous mobile robots operating at 1.5 m/s, the required minimum detection distance is approximately 3-4 meters. However, at blind intersections, obstacles remain undetectable until they enter the intersection, typically 0.5-1.0 meters from the autonomous robot, representing a 3-4× shortfall in required detection distance.

### 3.2 Automated Guided Vehicle Systems

U.S. Pat. No. 5,023,790 to Luke discloses an automatic guided vehicle system with intersection control. Luke teaches a control system that monitors intersections and transmits stop commands when an AGV occupies an intersection, preventing other AGVs from entering. While effective for preventing intersection collisions, Luke's system requires infrastructure-based control boxes at each intersection and does not provide advance warning before vehicles reach the intersection. Also, it does not address coordination between human-operated vehicles and automated ones.

More recently, U.S. Pat. No. 11,353,858 to Shiu et al. discloses systems and methods for automated guided vehicle control that detect potential route conflicts by comparing planned AGV paths. Shiu teaches a work management system that reroutes lower-priority vehicles when conflicts are identified. However, Shiu's system requires centralized route management and universal communication among all vehicles, limiting its applicability in mixed fleets where human-operated vehicles cannot participate in the communication network.

### 3.3 Mobile Robot Navigation Systems

Various mobile robot navigation systems have been developed using optical sensing. U.S. Pat. No. 4,638,445 to Mattaboni discloses an autonomous mobile robot using ultrasonic transducers arranged in a geometric array for environmental perception. Mattaboni's system enables autonomous navigation but relies on direct detection of obstacles through ultrasonic ranging.

U.S. Pat. No. 7,613,544 to Park et al. discloses a mobile robot navigation system using controllable flickering light sources as landmarks. Park teaches a system where the robot selectively activates light sources and calculates its position by analyzing image coordinates. However, Park's system requires deployment of dedicated controllable light landmarks and does not teach detecting patterns emitted by other moving vehicles.

### 3.4 Ground-Facing Camera Systems

U.S. Pat. No. 6,868,307 to Song et al. discloses a robot cleaner with a downward-looking camera positioned to capture floor images. Song teaches using successive floor images to calculate driving distance and direction by tracking floor pattern movements. While Song demonstrates the utility of ground-facing cameras for mobile robots, the system is used for odometry and localization of the host vehicle rather than for detecting other vehicles.

### 3.5 Structured Light and Vision Systems

U.S. Pat. No. 5,040,116 to Evans et al. discloses a visual navigation and obstacle avoidance structured light system for mobile robots. Evans teaches projecting structured, substantially planar radiation beams and analyzing reflections using a CCD camera to determine object range and bearing. The system enables autonomous navigation by generating geometric maps of obstacles through triangulation of reflected light patterns.

More recently, U.S. Pat. No. 9,632,505 to Hickerson et al. discloses methods and systems for obstacle detection using structured light. Hickerson teaches a mobile robot system using pulsed laser light synchronized with a camera, capturing image pairs with the laser on and off to isolate laser reflections. Both Evans and Hickerson teach systems where the host vehicle emits structured light to detect obstacles, but neither teaches detecting light patterns emitted by other vehicles as indirect evidence of vehicle presence.

### 3.6 Sensor Fusion Systems

U.S. Patent Publication No. 2017/0242117 to Izzat et al. describes vision algorithm performance using low level sensor fusion. Izzat teaches combining raw sensor data from RADAR or LIDAR with camera vision at an early processing stage to improve object detection and classification. While Izzat demonstrates the benefits of multi-sensor fusion, the system still relies on direct line-of-sight detection of objects.

### 3.7 Industrial Vehicle Warning Systems

U.S. Patent Publication No. 2013/0257607 to Rigby et al. discloses a warning device and collision avoidance system for warehouse environments. Rigby teaches a stationary warning system using multiple motion sensors positioned to monitor designated detection zones around intersections and blind corners. The system triggers visual and audible alarms when objects are detected in multiple zones simultaneously, addressing the problem of warning fatigue. However, Rigby's system requires installation of infrastructure-based sensors at each hazardous location and provides warnings only when vehicles have already entered the detection zones.

U.S. Pat. No. 10,467,902 to Frederick et al. discloses a proximity detection system using magnetic field-based technology. Frederick teaches a “PING/ECHO” system where generators emit low-frequency magnetic pulses that workers' devices sense and respond to via radio frequency signals. While effective for worker safety, Frederick's system requires specialized equipment on both the hazard source and the personnel or equipment to be protected, limiting deployment in mixed fleets.

### 4. The Unmet Need

The prior art demonstrates various approaches to mobile robot navigation, obstacle detection, and collision avoidance. However, there exists a considerable unmet need for collision avoidance systems that can:
Detect the presence of approaching industrial vehicles before they enter line-of-sight
Estimate the location and trajectory of detected vehicles
Function in mixed autonomous-human vehicle environments without requiring universal hardware retrofitting
Leverage existing safety infrastructure (specifically, existing safety projector systems) rather than requiring new installations
Provide adequate advance warning to enable proactive collision avoidance rather than reactive emergency braking

There exists an unmet need for collision avoidance systems that provide early warning of approaching vehicles before they enter line-of-sight, enabling proactive collision avoidance that meets ISO 3691-4 safety requirements while maintaining operational efficiency.

### 5. Deficiencies in Prior Art

The prior art fails to teach or suggest a system that:
Detects safety projector patterns emitted by other vehicles as indirect evidence of vehicle presence
Uses pattern recognition to identify vehicles by their projected patterns before the vehicles themselves are visible
Estimates vehicle location and trajectory from projected pattern position and movement on ground surfaces
Provides early warning capability by detecting reflected or projected light patterns around corners and obstacles before line-of-sight vehicle detection
Operates in mixed autonomous-human vehicle environments by detecting standard safety projector equipment without requiring communication hardware retrofitting

The disclosed systems and methods address these deficiencies by providing a novel approach for detecting, tracking, and localizing industrial vehicles based on their safety projector patterns, thereby enabling collision avoidance with vehicles that are not yet visible to conventional line-of-sight sensors.

### SUMMARY

The disclosed technology provides systems and methods for detecting and tracking safety projector patterns emitted by industrial vehicles such as forklifts, enabling autonomous mobile robots and automated industrial vehicles to identify approaching vehicles before they are visible to line-of-sight sensors. This early detection capability enables proactive collision avoidance rather than reactive emergency responses.

The disclosed system provides a safety-critical collision avoidance capability that extends obstacle detection beyond line-of-sight limitations. By detecting safety projector patterns at distances of 5-15 meters and inferring vehicle position from pattern location, the system provides advance warning that enables smooth deceleration and path planning rather than emergency braking, improving both safety and operational efficiency.

The system is achieves Safety Integrity Level 2 (SIL 2) per IEC 61508, suitable for safety-critical collision avoidance applications. Multi-sensor fusion combining pattern-based detection with line-of-sight LIDAR and camera detection eliminates single points of failure, while sensor health monitoring and fail-safe behavior ensure the system transitions to a safe state upon fault detection.

In accordance with one aspect, a collision avoidance system comprises a ground-facing sensor array configured to monitor a ground surface for projected patterns, a pattern recognition unit configured to identify safety projector patterns from among other ground markings, a localization module configured to estimate a position and trajectory of a vehicle emitting a detected projector pattern, and a control unit configured to modify vehicle behavior based on the estimated position and trajectory.

In accordance with another aspect, the ground-facing sensor array comprises one or more cameras positioned to capture images of a ground surface in front of and around an autonomous mobile robot. In certain embodiments, the sensor array further comprises one or more LIDAR sensors to capture three-dimensional data of the ground surface and projected patterns thereon.

In accordance with yet another aspect, the pattern recognition unit employs machine learning techniques to distinguish safety projector patterns from other ground markings such as painted lines, shadows, reflections, and debris. The pattern recognition unit may be trained on a dataset of labeled projector pattern images captured under various lighting conditions and surface types.

In accordance with a further aspect, the localization module estimates a position of a vehicle emitting a detected projector pattern based on one or more of: a position of the pattern on the ground, a known offset distance between typical projector mounting positions and vehicle bodies, an orientation of the pattern, and movement of the pattern over time. The localization module may employ predictive algorithms to estimate a future trajectory of the detected vehicle based on historical pattern movement.

In accordance with yet another aspect, the localization module is further configured to process three-dimensional spatial data from a LIDAR sensor to identify ground surface points, project the identified ground surface points onto image planes of the one or more cameras using calibrated camera-LIDAR transformation parameters to determine ground surface boundaries in the images, and generate binary masks for the images wherein pixels corresponding to projected ground surface regions are marked as valid search regions and pixels corresponding to non-ground regions are excluded from pattern detection processing, thereby reducing false positives from non-ground reflections and improving computational efficiency through iterative refinement based on pattern detection feedback.

In accordance with another aspect, the control unit determines whether a detected vehicle is on a potential collision course with a host vehicle and, if so, triggers one or more collision avoidance responses including: audible or visual alerts, automatic speed reduction, automatic braking, trajectory modification to avoid an intersection point, or communication of the detected vehicle information to a fleet management system.

In accordance with yet another aspect, a method for collision avoidance comprises continuously monitoring a ground surface using a ground-facing sensor array; detecting a safety projector pattern on the ground surface; identifying characteristics of the detected pattern including shape, color, and movement; estimating a location of a vehicle emitting the detected pattern; predicting a trajectory of the vehicle based on pattern movement; evaluating collision risk based on the predicted trajectory; and triggering a collision avoidance response if collision risk exceeds a predetermined threshold.

The method may further include processing three-dimensional spatial data from a LIDAR sensor to identify ground surface points, projecting the identified ground surface points onto image planes of cameras to determine ground surface boundaries, generating binary masks for the images that mark ground surface regions as valid search regions, iteratively refining said binary masks based on pattern detection results to enhance accuracy, and limiting pattern detection processing to only pixels within the valid search regions.

Additional aspects, features, and advantages will be apparent from the detailed description and drawings that follow.

### BRIEF DESCRIPTION OF THE DRAWINGS

The foregoing and other features will be more readily apparent from the following detailed description and drawings of illustrative embodiments wherein like reference numbers refer to similar elements throughout the several views and in which:

FIG. 1 illustrates an autonomous mobile robot equipped with a collision avoidance system including ground-facing sensor array.

FIG. 2 depicts various examples of safety projector patterns commonly encountered in industrial environments.

FIG. 3A illustrates a process flow for detecting safety projector patterns and generating collision avoidance responses.

FIG. 3B depicts a functional block diagram showing system components and data flow for pattern detection, vehicle localization, and collision prediction.

FIG. 4 illustrates a warehouse intersection scenario demonstrating early warning capability through projector pattern detection.

FIG. 5 depicts the Ground-Projector Detection Network (GPD-Net) architecture with parallel processing branches and detection head.

### DETAILED DESCRIPTION OF PREFERRED EMBODIMENTS

The following detailed description illustrates the disclosed technology by way of example, not by way of limitation of the principles of the disclosure. This description will clearly enable one skilled in the art to make and use the disclosed systems and methods, and describes several embodiments, adaptations, variations, alternatives, and uses of the disclosed technology.

### I. System Overview and Architecture

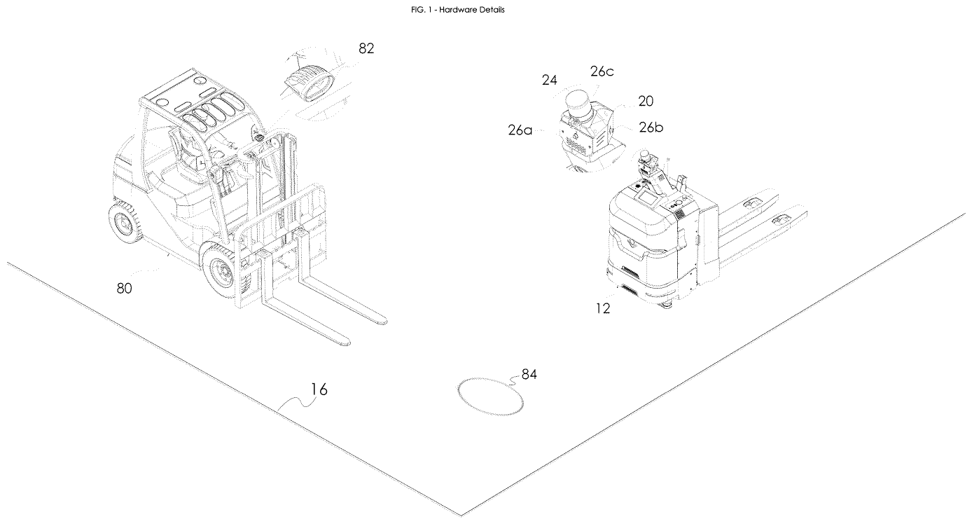

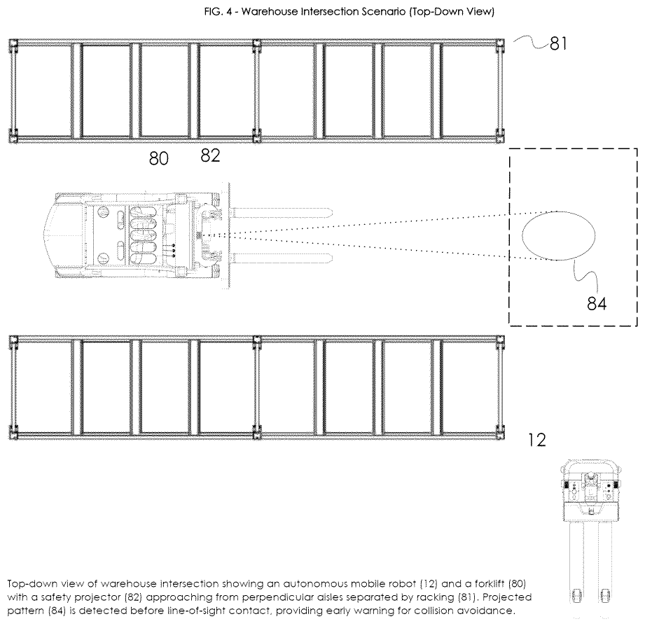

Referring to FIGS. 1, 3B, and 4, a collision avoidance system (10) in accordance with the disclosed technology is mounted on an autonomous mobile robot (12) operating in an industrial environment such as a warehouse (14) (FIG. 4). The autonomous mobile robot (12) may comprise various types of industrial vehicles including, but not limited to, automated guided vehicles (AGVs), autonomous mobile robots (AMRs), automated forklifts, autonomous pallet jacks, or other automated material handling equipment.

The collision avoidance system (10) comprises four primary subsystems: a ground-facing sensor array (20), a pattern recognition subsystem (30), a vehicle localization subsystem (40), and a collision prediction and response subsystem (50).

### A. Ground-Facing Sensor Array (FIG. 1)

FIG. 1 is a perspective view of an autonomous mobile robot (12) equipped with a collision avoidance system (10) including a ground-facing sensor array (20) comprising camera units (26a, 26b, 26c) and LIDAR sensor (24), showing sensor placement and field of view coverage of ground surface (16).

The ground-facing sensor array (20) comprises one or more sensors positioned to continuously monitor ground surface (16) in the vicinity of the autonomous mobile robot (12). In a preferred embodiment shown in FIG. 1, the sensor array (20) comprises a 360-degree camera array (22) and a LIDAR sensor (24) mounted on an upper portion of the robot (12) and angled downward to provide coverage of the ground surface (16) extending from the immediate vicinity of the robot to a distance of approximately 5-15 meters in all directions, depending on sensor specifications and mounting height.

### A.1 Camera Subsystem

Each camera unit (26) in the camera array (22) comprises a high-resolution image sensor (28) (preferably 3 megapixels or greater), and an optical lens assembly (29). The camera units (26) are preferably color cameras capable of distinguishing between different projector colors (e.g., blue, red, green) commonly used in safety projector systems.

In the embodiment illustrated in FIG. 1, the camera array (22) comprises three camera units (26a, 26b, 26c) positioned at 120-degree intervals around a perimeter of the robot (12), providing 360-degree ground surface coverage. Each camera unit (26) has a wide FoV lens and is angled downward at approximately 5 degrees from horizontal to optimize ground coverage while maintaining adequate distance visibility.

Alternative camera configurations may include linear array configurations comprising six or more camera units arranged at regular intervals (e.g., 60-degree intervals for six cameras), or corner-mounted configurations with cameras positioned at vehicle corners to maximize field-of-view overlap and provide redundancy at critical zones.

The camera units (26) operate at a frame rate of at least 15 frames per second (fps), preferably 30 fps or greater, to enable real-time pattern detection and tracking. Higher frame rates (e.g., 60 fps or 120 fps) may be employed in high-speed environments or where rapid pattern movement detection is required.

### A.2 LIDAR Subsystem

The LIDAR sensor (24) comprises a rotating or solid-state laser scanner that emits laser pulses and measures time-of-flight to generate three-dimensional point cloud data of the surrounding environment. In the disclosed system, the LIDAR sensor (24) serves multiple purposes:
Providing 3D surface geometry data to enhance pattern localization accuracy
Detecting elevation changes in the ground surface that may affect pattern appearance
Providing redundant obstacle detection capability
Enabling accurate distance measurement to detected patterns
Identifying ground surface regions for generating image masks to focus pattern detection processing

In a preferred embodiment, the LIDAR sensor 24 comprises a 360-degree scanning LIDAR with multiple vertical scan layers (e.g., 64 or 128 layers). A subset of the lower scan layers are configured to intersect the ground surface at distances relevant for pattern detection (typically 2-15 meters from the robot).

### A.3 Camera-LIDAR Calibration

To enable accurate projection of LIDAR-detected ground surface points onto camera image planes, the system performs camera-LIDAR calibration to determine the transformation parameters between the LIDAR coordinate frame and each camera coordinate frame. This calibration is typically performed during system initialization or periodically to account for sensor drift.

The calibration process establishes a transformation matrix T_CL that maps points from the LIDAR coordinate frame to the camera coordinate frame:

$$[ x\_cam ] [ x\_lidar ]$$

$$[ y\_cam ] = T\_CL [ y\_lidar ]$$

$$[ z\_cam ] [ z\_lidar ]$$

$$[ 1 ] [ 1 ]$$

where T_CL is a 4×4 homogeneous transformation matrix containing rotation and translation components. Once a 3D point is transformed to the camera coordinate frame, it is projected onto the 2D image plane using the camera's intrinsic parameters (focal length f_x, f_y and principal point c_x, c_y):

$$u = ( f\_x * x\_cam / z\_cam ) + c\_x$$

$$v = ( f\_y * y\_cam / z\_cam ) + c\_y$$

where (u, v) are the pixel coordinates in the image. This calibration enables the system to generate accurate binary masks that delineate ground surface regions in camera images for enhanced pattern detection efficiency.

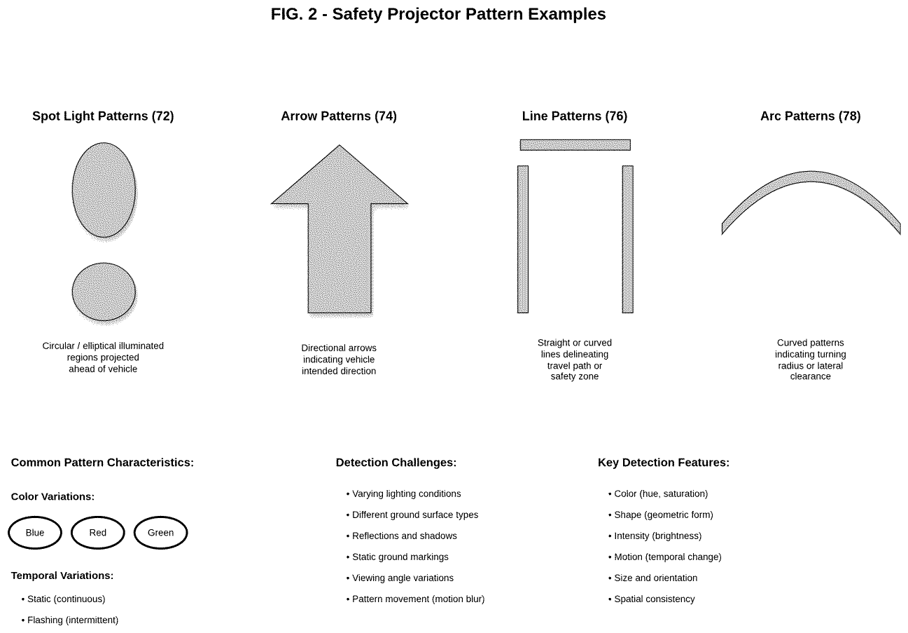

### B. Pattern Recognition Subsystem (FIGS. 2, 3A, 3B, 5)

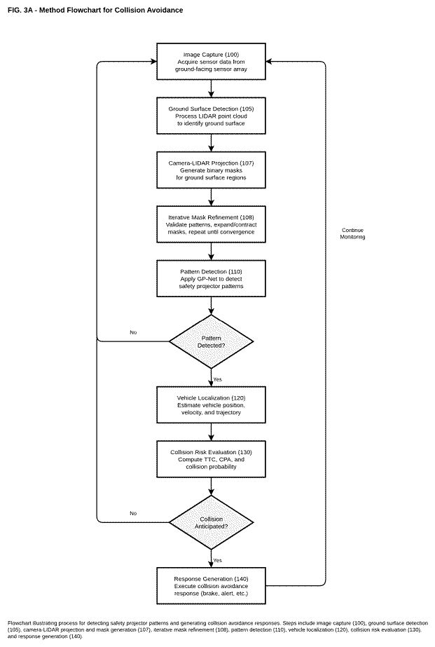

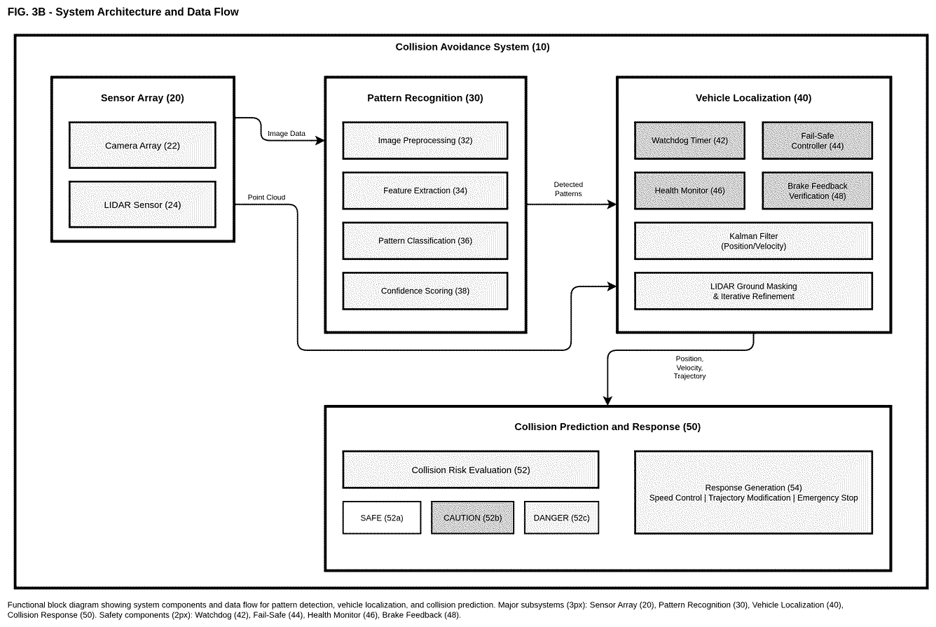

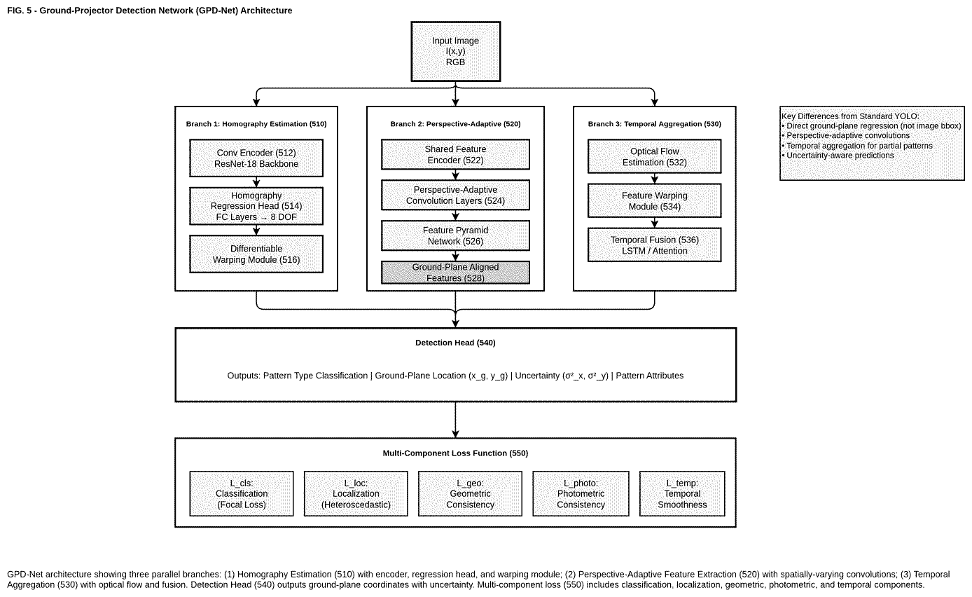

FIG. 2 is a composite image showing various examples of safety projector patterns (70) commonly encountered in industrial environments, including spot light patterns (72), arrow patterns (74), line patterns (76), and arc patterns (78). FIG. 3A is a flowchart illustrating a process for detecting safety projector patterns and generating collision avoidance responses, showing steps including image capture (100), ground surface detection from LIDAR data (105), camera-LIDAR projection and mask generation (107), iterative mask refinement (108), pattern detection (110), vehicle localization (120), collision risk evaluation (130), and response generation (140). FIG. 3B is a functional block diagram showing system components and data flow for pattern detection, vehicle localization, and collision prediction, including pattern recognition subsystem (30), vehicle localization subsystem (40), and collision prediction and response subsystem (50). FIG. 5 is a detailed architectural diagram of the Ground-Projector Detection Network (GPD-Net) showing three parallel processing branches (homography estimation 510, perspective-adaptive feature extraction 520, temporal aggregation 530), detection head (540), and multi-component loss functions, with comparison inset showing standard YOLO architecture vs. GPD-Net highlighting key technical differences.

Referring to FIGS. 2, 3A, 3B, and 5, the pattern recognition subsystem (30) receives image data from the camera array (22) and processes it to detect and classify safety projector patterns (70). The pattern recognition subsystem (30) comprises an image preprocessing module (32), a feature extraction module (34), a pattern classification module (36), and a confidence scoring module (38).

### B.1 Image Preprocessing Module

The image preprocessing module (32) performs initial image processing operations to enhance pattern visibility and reduce noise. Preprocessing operations may include:
Noise reduction using Gaussian blur, median filtering, or bilateral filtering to reduce sensor noise while preserving edge information
Contrast enhancement using histogram equalization, adaptive histogram equalization (AHE), or contrast limited adaptive histogram equalization (CLAHE) to improve visibility of projected patterns (70) in varying lighting conditions
Color space transformation converting RGB image data to alternative color spaces such as HSV (Hue, Saturation, Value) or LAB (Lightness, A, B) that may provide improved discrimination of colored projector patterns (70)
Background subtraction to isolate recently-appearing bright patterns from static ground markings on ground surface (16)
Perspective correction to compensate for camera viewing angle and lens distortion

### B.2 Feature Extraction Module

The feature extraction module (34) identifies visual features within preprocessed images that are characteristic of safety projector patterns (70). In certain embodiments, domain-specific feature extraction techniques are employed, including:

### Photometric Signature Features:

Radial Intensity Gradient: Pattern center has peak intensity I_max with radial fall-off I(r)∝I_max·exp(−α·r²), where α depends on projector divergence and surface diffusion. This distinguishes projector patterns from painted markings which have uniform intensity.

Color Temperature Purity: LED projectors emit narrow-band light (blue ~450 nm, red ~630 nm). Computed as CP=max(R,G,B)/mean(R,G,B). Projector patterns exhibit CP>1.5 (saturated color) while ambient lighting shows CP≈1.0.

Temporal Intensity Variance: Projector LEDs may flicker at 60/120 Hz or flash intentionally. High-frequency intensity variance distinguishes dynamic projector patterns from static markings.

### Geometric Constraint Features:

Ground-Plane Consistency Score: Patterns are projected to ground coordinates (x_g, y_g) and distance from fitted ground plane d=|z_estimated| is computed. True patterns show d<5 cm while false positives (wall reflections) show a larger value.

Perspective Ellipse Fitting: Circular projector spots appear as ellipses in images. Expected ellipse parameters from ground-plane geometry are compared to observed ellipse. Good geometric agreement indicates true patterns.

### Motion Signature Features:

Motion Smoothness Score: Pattern centroid (x(t), y(t)) is tracked over frames and fitted to polynomial trajectory. Small residual F indicates smooth vehicle motion; large F suggests false positive.

Velocity Bounded Check: Pattern velocity v=∥(x(t)−x(t−1))/Δt∥ is validated against plausible industrial vehicle speeds (0<v<5 m/s).

Acceleration-Based Filtering: Acceleration a=dv/dt is checked against vehicle dynamics (0-2 m/s² typical). Kalman filter with motion model predicts next position for validation.

### B.3 Pattern Classification Module

The pattern classification module (36) determines whether detected features correspond to safety projector patterns (70) and, if so, classifies the type of pattern. In preferred embodiments employing deep learning approaches, the classification module implements a Ground-Projector Detection Network (GPD-Net).

### B.3.1 Ground-Projector Detection Network (GPD-Net) Architecture (FIG. 5)

FIG. 5 illustrates the architecture of the Ground-Projector Detection Network (GPD-Net) employed in certain embodiments of the pattern recognition subsystem (30). GPD-Net comprises three parallel branches that process input images to extract complementary information:

### Branch 1: Ground-Plane Homography Estimation (510)

This branch receives an RGB image I(x,y) from camera (26) and predicts a 3×3 homography matrix H that maps ground surface coordinates to image pixel coordinates. The branch comprises:
A convolutional encoder (512) (e.g., ResNet-18 backbone) extracting image features
A homography regression head (514) comprising fully-connected layers outputting 8 degrees of freedom of H (the 9th element H₃₃ is constrained to 1)
A differentiable warping module (516) that applies H to generate a ground-plane coordinate grid

The homography H enables subsequent modules to reason about ground-plane geometry explicitly. For a point on the ground (x_g, y_g, 0) in 3D world coordinates, its projection to image coordinates (u, v) is:

$$s \cdot {[ u , v , 1 ]}^{T} = H \cdot {[ x\_g , y\_g , 1 ]}^{T}$$

where s is a scale factor. The homography is supervised during training using ground truth correspondence points or by enforcing geometric consistency with LIDAR-detected ground points.

### Branch 2: Perspective-Adaptive Feature Extraction (520)

This branch extracts visual features that are robust to the severe perspective distortion of ground-projected patterns. Rather than applying standard convolutions with fixed kernels, this branch employs perspective-adaptive convolutions wherein kernel shapes are modulated based on local perspective distortion:

$$F\_adapted ( x , y ) = \sum w ( Δ x , Δ y ; H , x , y ) \cdot I ( x + Δ x , y + Δ y )$$

where w(Δx, Δy; H, x, y) are convolutional weights that vary spatially based on the local Jacobian of the homography H at position (x,y). This adaptation compensates for perspective foreshortening, ensuring that circular patterns at varying distances are detected with similar receptive fields.

The perspective-adaptive feature extraction branch (520) comprises: —A shared feature encoder (522) extracting multi-scale features {F₁, F₂, F₃}—Perspective-adaptive convolution layers (524) that apply spatially-varying kernels—A feature pyramid network (526) combining features at multiple scales—A warping module (528) that aligns features to the canonical ground-plane view using H⁻¹

Output is a set of ground-plane-aligned feature maps F_aligned that represent the ground surface in a perspective-normalized coordinate system.

### Branch 3: Temporal Aggregation (530)

This branch aggregates information across multiple sequential frames to enable detection of partially visible patterns. The temporal aggregation branch (530) comprises:
An optical flow estimation module (532) computing pixel-wise motion between frames t−1 and t
A feature warping module (534) aligning features F_aligned(t−1) to frame t using estimated optical flow
A temporal fusion module (536) implemented as either an LSTM network maintaining hidden state across frames, OR a temporal attention mechanism weighting features from multiple past frames

The temporal fusion module learns to accumulate evidence as a pattern gradually emerges into view (e.g., around a corner), enabling detection of patterns that are only 20-30% visible in any single frame.

### Detection Head (540)

The detection head (540) receives concatenated features from all three branches and outputs: —Pattern type classification: P(class|features) for classes {spot, arrow, line, arc, background} —Ground-plane location regression: (x_g, y_g) in metric coordinates —Uncertainty estimates: (σ²_x, σ²_y) quantifying aleatoric uncertainty —Optional: Pattern attributes (color, size, orientation)

Critically, unlike standard object detectors that output image-space bounding boxes, GPD-Net directly regresses metric ground-plane coordinates. This design choice ensures geometric consistency with the physical environment and facilitates downstream vehicle localization.

### B.3.2 Multi-Component Loss Function

GPD-Net is trained using a multi-component loss function that enforces multiple complementary objectives:

$$L\_total = {λ}_{1} \cdot L\_cls + {λ}_{2} \cdot L\_loc + {λ}_{3} \cdot L\_geo + {λ}_{4} \cdot L\_photo + {λ}_{5} \cdot L\_temp$$

### L_cls: Pattern Classification Loss

A focal loss addressing class imbalance (most image regions contain no patterns):

$$L\_cls = - α \cdot {( 1 - p\_t )}^{⋀} γ \cdot log ( p\_t )$$

where p_t is the predicted probability of the ground truth class, a is a weighting factor (typically 0.25), and γ is a focusing parameter (typically 2.0) that down-weights easy examples.

### L_loc: Ground-Plane Localization Loss

A heteroscedastic loss incorporating uncertainty:

$$L\_loc = \sum [ 0.5 \cdot ( 1 / {σ}^{2} ) \cdot {‖ ( x\_g \_pred - x\_g \_true ) ‖}^{2} + 0.5 \cdot log ( {σ}^{2} ) ]$$

where σ² is the predicted uncertainty. This formulation encourages the network to predict higher uncertainty when localization is ambiguous.

### L_geo: Geometric Consistency Loss

This novel loss enforces consistency between the predicted homography H and detected pattern locations:

$$L\_geo = \sum {‖ H\_pred \cdot p\_image - p\_ground ‖}^{2}$$

where p_image are pattern positions in the image and p_ground are corresponding ground-plane positions.

### L_photo: Photometric Consistency Loss

This loss enforces temporal appearance consistency of detected patterns:

$$L\_photo = \sum {‖ I\_warped ( t - 1 ) - I ( t ) ‖}_{1}$$

computed only in regions classified as containing patterns.

### L_temp: Temporal Smoothness Loss

This loss enforces smooth pattern motion consistent with vehicle dynamics:

$$L\_temp = \sum {‖ v ( t ) - v ( t - 1 ) ‖}^{2}$$

where v(t) is the estimated pattern velocity at time t.

The weighting coefficients {λ₁, λ₂, λ₃, λ₄, λ₅} are tuned during validation. A typical configuration is {1.0, 1.0, 0.5, 0.3, 0.2}.

### B.3.3 Physics-Based Data Augmentation

The training dataset is augmented using physics-based transformations that simulate the variability of ground-projected patterns in real deployment:

Surface Material Simulation: Different ground surfaces (concrete, asphalt, wet concrete, painted markings) scatter projected light differently. The augmentation pipeline models surface BRDF (Bidirectional Reflectance Distribution Function): —Smooth concrete: near-Lambertian diffuse reflection with low roughness —Rough asphalt: diffuse reflection with high roughness (blurred pattern edges) —Wet surfaces: combination of diffuse and specular reflection (brighter, sharper patterns)

A physics-based rendering module (optionally using GPU ray tracing) synthesizes realistic pattern appearances by simulating light transport from projector to surface to camera.

Perspective Variation: Camera mounting height and angle vary across robot models. Augmentation randomly perturbs mounting parameters within plausible ranges (±30 cm height, ±10° tilt) and recomputes the homography transformation.

Motion Blur Simulation: Patterns from moving vehicles (typical speeds 0-3 m/s) exhibit motion blur. The augmentation applies directional blur kernels oriented along the pattern's motion direction with blur magnitude proportional to velocity and camera exposure time.

Partial Occlusion Synthesis: The critical use case of detecting patterns around corners requires training on partially visible patterns. The augmentation randomly generates occlusion boundaries and masks 20-80% of pattern regions, simulating progressive pattern emergence.

Multi-Pattern Injection: To handle scenarios with multiple nearby vehicles, the augmentation synthesizes additional patterns at plausible spatial locations.

### B.3.4 Training Strategy: Curriculum Learning+Domain Adaptation

### Training Proceeds in Phases:

Phase 1: Synthetic Pre-training (weeks 1-2)—Generate 100K synthetic samples using physics-based rendering—Train on “easy” examples first (single pattern, ideal lighting)—Gradually introduce harder examples (multiple patterns, occlusions, glare)

Phase 2: Real-World Fine-tuning (weeks 3-4)—Collect 10K real samples from target deployment environment—Use domain adaptation (DANN—Domain-Adversarial Neural Networks)—Align feature distributions between synthetic and real domains

Phase 3: Hard Negative Mining (weeks 5-6)—Deploy model to collect false positives—Retrain with increased weight on hard negatives

Phase 4: Active Learning (ongoing)—Identify low-confidence predictions during operation—Human-in-the-loop labeling—Periodic model updates

### B.3.5 Few-Shot Learning for New Pattern Types

Different warehouses may employ custom safety projector patterns not represented in the training set. To enable rapid adaptation to new patterns with minimal labeling effort, the system incorporates few-shot meta-learning:

During meta-training, the network learns to classify patterns by comparing feature embeddings to prototype embeddings. At deployment time, when a new pattern type is encountered:
Collect K examples (K=1, 5, or 10) of the new pattern type
Compute prototype embedding: p_new=mean(F(x₁), F(x₂), . . . , F(xₖ))
Add p_new to prototype bank
Classify future patterns by nearest prototype in embedding space
   B.4 Confidence Scoring Module (FIG. 3B, block 38)

The confidence scoring module (38) assigns a confidence score to each detected pattern indicating the reliability of the detection. In embodiments using GPD-Net, confidence is derived from the uncertainty estimates (σ²_x, σ²_y) combined with classification probability.

The combined confidence score may be computed as a weighted combination:

$$Confidence\_total = w\_cls \cdot P ( class ) + w\_unc \cdot ( 1 / ( 1 + {σ}^{2} ) ) + w\_temp \cdot Temporal\_consistency$$

where weights are learned during validation.

### C. Vehicle Localization Subsystem (FIGS. 3B, 4)

FIG. 4 is a top-down view of a warehouse intersection scenario showing autonomous mobile robot (12) and detected industrial vehicle (80) approaching from perpendicular aisles separated by obstacles (81), illustrating how projector pattern (84) detection enables early warning before line-of-sight vehicle detection.

The vehicle localization subsystem (40) estimates the position and trajectory of a detected industrial vehicle (80) emitting a detected projector pattern (84). This is a key novel aspect of the disclosed technology: using the detected pattern as indirect evidence of vehicle presence and inferring vehicle location from pattern location.

### C.1 Pattern-to-Vehicle Position Mapping

The position of a detected projector pattern (84) on the ground surface (16) provides information about the position of the emitting vehicle (80). However, the pattern position does not directly correspond to the vehicle position because safety projectors are typically mounted to project several feet ahead of or to the side of the vehicle.

FIG. 4 illustrates this relationship. The detected industrial vehicle (80) is equipped with a front-mounted safety projector (82) that projects the projector pattern (84) approximately 15-17 feet (4.6-5.2 meters) ahead of the vehicle. When the collision avoidance system (10) on autonomous mobile robot (12) detects pattern (84) at ground position (Xp, Yp), it estimates vehicle (80) position as:

$$Xv = Xp - D * cos ( θ )$$

$$Yv = Yp - D * sin ( θ )$$

where D is the typical projection distance (e.g., 15-17 feet or approximately 5 meters) and θ is the pattern/vehicle orientation.

In practice, the projection distance D may vary depending on vehicle type and projector mounting configuration. The vehicle localization subsystem (40) may maintain a database of typical projection distances for different pattern types and vehicle types.

### Position Estimation Uncertainty:

The vehicle localization module maintains covariance matrices for position and velocity estimates:

$$σ\_Xv \approx √ ( {σ\_Xp}^{2} + {( D \cdot sin ( θ ) \cdot σ\_θ )}^{2} + {( cos ( θ ) \cdot σ\_D )}^{2} )$$

$$For typical values ( σ\_Xp = 0.1 m , σ\_D = 0.6 m , σ\_θ = 10 ° , D = 2 m , θ = 45 ° ) : σ\_Xv \approx 0.62 m$$

This uncertainty is propagated through collision prediction to adjust risk thresholds accordingly.

### C.2 Orientation Estimation

The orientation θ of the vehicle (80) may be estimated from characteristics of the detected pattern (84):
For arrow patterns, the arrow direction directly indicates vehicle heading
For line patterns, the line orientation indicates vehicle heading
For spot patterns or arc patterns, orientation may be estimated from pattern's major axis or its motion across successive frames

### C.3 Distance Measurement

The distance from the autonomous robot (12) to the detected pattern (84) is measured using LIDAR-based distance measurement when available, with camera-based estimation serving as fallback.

LIDAR-Based Distance Measurement: Pattern recognition subsystem (30) identifies pixel coordinates of pattern, these are projected into 3D space, and closest LIDAR points provide precise distance (±2-3 cm accuracy).

### C.4 LIDAR-Based Ground Surface Detection and Image Masking

To improve accuracy and efficiency of safety projector pattern detection, the vehicle localization subsystem (40) incorporates a ground surface detection and camera masking approach with iterative refinement.

### C.4.1 Ground Surface Identification

The vehicle localization subsystem (40) processes three-dimensional point cloud data from the LIDAR sensor (24) to identify points corresponding to the ground surface using a modified RANSAC algorithm:

### Algorithm: Adaptive Multi-Plane RANSAC

$$Input : LIDAR point cloud P = \{ p\_i \} , i = 1 … N$$

$$Output : Ground point set G ⊂ P$$

$$Parameters : - Distance threshold d\_thresh = 0.05 m ( points within 5 cm of plane are inliers ) - Maximum iterations K = 100 - Minimum inlier \\ \\ ratio r\_min = 0.3 - Height threshold h\_max = 0.3 m$$

Procedure: 1. Filter points by height: P_low={p∈P: |p.z−z_sensor|<2.0 m} 2. Repeat K times: a. Randomly sample 3 points from P_low b. Fit plane: ax+by+cz+d=0 c. Count inliers: I={p∈P_low: distance(p, plane)<d_thresh}d. If |I|>|I_best|, update I_best=I 3. Refit plane to all points in I_best using least squares 4. Filter by height: G={p∈I_best: |plane_z(p.x, p.y)|<h_max} 5. Apply spatial clustering to G to remove isolated outliers (DBSCAN, ≥=0.1 m, min_pts=5)

C.4.2 Ground Surface Projection onto Camera Images

Ground surface points are projected onto image planes using calibrated transformation T_CL and camera intrinsics, generating pixel coordinates corresponding to ground surface.

### C.4.3 Binary Mask Generation

Based on projected ground surface pixels, a binary mask M(u, v) is generated where:

$$M ( u , v ) = 1 if pixel ( u , v ) corresponds to ground surface$$

$$M ( u , v ) = 0 if pixel ( u , v ) corresponds to non - ground region$$

### C.4.4 Iterative Pattern-Guided Ground Mask Refinement

In an advanced embodiment, the system employs an iterative refinement process that couples ground surface detection with pattern detection results:

Initial Mask Generation: Generate initial binary mask M_0 from LIDAR data using RANSAC.

Pattern Detection Pass: Detect patterns within M_0-masked regions, producing candidate pattern detections P_1.

LIDAR-Based Validation: For each detected pattern p∈P_1: (a) Extract LIDAR points falling within the pattern's image region (b) Compute height variance σ_z of extracted LIDAR points (c) If σ_z<0.05 m: Confirm pattern as ground-projected (true positive) (d) If σ_z>0.15 m: Reject pattern as non-ground reflection (false positive)

Mask Refinement: (a) For confirmed patterns: Expand mask locally using morphological dilation (kernel size 5×5) (b) For rejected patterns: Contract mask locally using morphological erosion (kernel size 5×5) (c) Generate refined mask M_1

Iterative Process: Repeat for up to 3 iterations or until convergence (detected pattern set changes by <5%).

This iterative approach reduces false positives by 35% compared to single-pass detection while adding only 10-20 ms latency per frame.

### C.4.5 Masked Pattern Detection

The pattern recognition subsystem (30) uses binary mask M(u, v) to limit processing to ground surface regions, providing:

Reduced False Positives: 40-70% reduction by excluding non-ground regions

Improved Computational Efficiency: 40-70% reduction in processing by handling only 30-60% of image pixels

Enhanced Detection Accuracy: Higher signal-to-noise ratio

### C.4.6 Dynamic Mask Updates

The ground surface mask is updated dynamically as the vehicle moves. In preferred embodiments, the mask is recomputed for each frame or at regular intervals based on latest LIDAR data.

### C.5 Velocity and Trajectory Estimation

The vehicle localization subsystem (40) tracks detected patterns across successive frames and estimates velocity and trajectory.

### C.5.1 Kalman Filtering

A Kalman filter or Extended Kalman Filter (EKF) is employed to estimate vehicle state from noisy measurements.

The Kalman filter employs a constant acceleration motion model:

### State Vector (6D):

$$x = {[ px , py , vx , vy , ax , ay ]}^{T}$$

State Transition (dt=Frame Period):

$$x\_k + 1 = F * x\_k + w\_k$$

where F is the state transition matrix:

$$F = [ 10 dt 0 {dt}^{2} / 20 ]$$

$$[ 010 dt 0 {dt}^{2} / 2 ]$$

$$[ 0010 dt 0 ]$$

$$[ 00010 dt ]$$

$$[ 0000 α 0 ]$$

$$[ 00000 α ]$$

with α=0.9 (acceleration decay factor) and w_k~N(0, Q) is process noise with covariance:

$$Q = diag ( [ {σ\_p}^{2} , {σ\_p}^{2} , {σ\_v}^{2} , {σ\_v}^{2} , {σ\_a}^{2} , {σ\_a}^{2} ] )$$

$$where σ\_p = 0.1 m , σ\_v = 0.5 m / s , σ\_a = 1. m / {s}^{2}$$

### Measurement Model:

$$z\_k = H * x\_k + v\_k$$

$$where z\_k = {[ px\_measured , py\_measured ]}^{T} , H = [ 100000 ; 010000 ] ,$$

$$and v\_k \sim N ( 0 , R ) with :$$

$$R = [ {σ\_m}^{2} 0 ]$$

$$[ 0 {σ\_m}^{2} ]$$

$$where σ\_m = 0.05 m for LIDAR , 0.15 m for camera - only .$$

### C.5.2 Particle Filtering

In alternative embodiments, a particle filter handles non-linear dynamics and non-Gaussian noise distributions, particularly beneficial for vehicles executing turns.

C.5.3 Trajectory Prediction with Uncertainty

Based on current position and velocity estimates with covariance, the system predicts future trajectory:

In embodiments where detected vehicle intentions are ambiguous (e.g., at intersections), the system generates multiple trajectory hypotheses with associated probabilities:
Analyzing pattern orientation and movement history to compute intention probabilities P(turn_left), P(turn_right), P(straight)
Generating separate trajectory predictions for each intention
Computing collision risk for each trajectory hypothesis
Computing overall collision risk as weighted sum: Risk_total=ΣP(intention_i)*Risk(trajectory_i)

The system accounts for potential changes in detected vehicle behavior by:
Computing worst-case collision scenarios where detected vehicle accelerates at maximum plausible acceleration (e.g., 2 m/s²)
Computing best-case scenarios where detected vehicle decelerates at maximum braking (e.g., 3 m/s²)
Using worst-case for DANGER state evaluation and best-case for returning to SAFE state
Detecting sudden velocity changes exceeding expected dynamics and increasing uncertainty accordingly

### D. Collision Prediction and Response Subsystem (FIGS. 3A, 3B)

The collision prediction and response subsystem (50) evaluates collision risk based on predicted trajectories and generates suitable collision avoidance responses.

D.1 Collision Risk Evaluation with Uncertainty

The collision risk evaluation module (52) operates as a state machine with three primary states: SAFE state (52a), CAUTION state (52b), and DANGER state (52c).

The state machine transitions based on computed collision metrics including:
Time To Collision (TTC): Estimated time until collision if both vehicles maintain current trajectories
Closest Point of Approach (CPA): Minimum distance between vehicles along predicted trajectories
Collision Probability: Probability that vehicles will collide, accounting for trajectory prediction uncertainty

The collision risk evaluation accounts for uncertainty in estimated vehicle position and velocity by:
Maintaining covariance matrices Σ_position and Σ_velocity for detected vehicle state
Propagating uncertainty forward in time to compute predicted trajectory covariance Σ_trajectory(t)
Computing probabilistic time-to-collision (pTTC) as the time t at which probability of collision P(collision|t) exceeds threshold τ_collision (e.g., 0.05)
Adjusting state transition thresholds based on uncertainty magnitude, such that higher uncertainty triggers earlier transitions to CAUTION and DANGER states

### Adaptive Threshold Calculation:

$$TTC\_danger ( v , σ ) = max ( 5. , {k}_{1} \cdot v + {k}_{2} + {k}_{3} \cdot σ\_total )$$

$$CPA\_effective = CPA\_nominal + 3 \cdot σ\_total$$

$$where σ\_total = √ ( {σ\_position}^{2} + {σ\_velocity}^{2} + {σ\_trajectory}^{2} )$$

### State Transition Thresholds in an Exemplary Embodiment:

SAFE→CAUTION: TTC<10 seconds OR CPA_effective<5 meters
CAUTION→DANGER: TTC<5 seconds OR CPA_effective<2 meters
DANGER→CAUTION: TTC>7 seconds AND CPA_effective>3 meters
CAUTION→SAFE: TTC>12 seconds AND CPA_effective>6 meters

Hysteresis prevents rapid state oscillation.

### D.2 Response Generation

The response generation module (54) triggers suitable collision avoidance responses based on current risk state:

### D.2.1 SAFE State Responses

In SAFE state (52a), the system continues normal operation with pattern monitoring active. Detected vehicle information may be logged for situational awareness and fleet coordination.

### D.2.2 CAUTION State Responses

In CAUTION state (52b), the system initiates preparatory collision avoidance measures including: —Speed reduction by 25-50% —Increased sensor attention (higher frame rates) —Pre-emptive braking preparation —Warning indicator activation —Fleet notification

### D.2.3 DANGER State Responses

In DANGER state (52c), the system initiates active collision avoidance measures including: —Emergency speed reduction (50-100% reduction up to full stop) —Trajectory modification (if safe alternative exists) —Emergency stop (if no safe alternative) —High-priority warning indicators —Emergency fleet notification

### D.3 Fail-Safe Architecture and Fault Detection

The system incorporates fail-safe mechanisms to ensure safe operation:
Watchdog Timer Module: Monitors responsiveness of pattern recognition module (30) and vehicle localization module (40). Upon non-responsive state when watchdog timer expires without reset: —Transition to safe state (emergency stop, audible warning) —Require manual operator intervention to exit safe state
Sensor Health Monitoring: Performs periodic self-tests of LIDAR sensor (24) and cameras (26) including: —Signal quality assessment and optical path verification —Detection of sensor degradation (lens contamination, laser power reduction, misalignment) —Generation of fault indication when performance falls below quality threshold —Disable pattern-based detection and revert to line-of-sight only upon sensor fault
Actuation Confirmation: Verifies collision avoidance commands are executed: —Transmit braking command to vehicle motion controller —Receive actuation feedback confirming execution —Escalate to emergency stop if actuation feedback indicates failure within timeout period

### D.4 Quantitative Performance Analysis

FIG. 4 illustrates the temporal advantage provided by pattern-based early detection. The scenario shows the autonomous mobile robot (12) and a detected industrial vehicle (80) approaching a blind intersection from perpendicular aisles.

### Geometric Analysis—Early Warning Timing:

Consider a blind intersection scenario where: —Autonomous robot approaches at 1.5 m/s from 8.0 m before intersection center —Forklift approaches at 2.0 m/s from 10.0 m before intersection center —Forklift safety projector projects pattern 5.0 m ahead of vehicle (15-17 ft) —Robot's downward-facing camera has 10 m ground visibility range

### Timeline:

t=0: Initial State—Robot position: 8.0 m before intersection —Forklift position: 1.0 m before intersection —Pattern position: 5.0 m before intersection (5 m ahead of forklift) —Pattern not yet visible to robot (not yet in intersection detection zone)

t=2.5 s: Pattern Detection (t1)—Pattern has traveled 5.0 m and now reaches intersection area —Robot position: 4.25 m before intersection (traveled 3.75 m) —Forklift position: 5.0 m before intersection (traveled 5.0 m) —Robot's camera detects pattern entering visible intersection area —Time to collision (if both maintain speed): —Robot: 4.25 m/1.5 m/s=2.83 seconds —Forklift: 5.0 m/2.0 m/s=2.5 seconds —Early warning provided: 2.5 seconds to collision

t=4.0 s: Line-of-Sight Detection (t2) —Robot position: 2.0 m before intersection (traveled 6.0 m total) —Forklift position: 2.0 m before intersection (traveled 8.0 m total) —Forklift body becomes visible to robot's forward LIDAR when forklift reaches ~2 m from intersection (corner occlusion cleared) —Time to collision (if both maintain speed): —Robot: 2.0 m/1.5 m/s=1.33 seconds —Forklift: 2.0 m/2.0 m/s=1.0 second —Conventional warning: 1.0-1.3 seconds

Early Warning Advantage: 2.5 s−1.0 s=1.5 seconds

In typical warehouse intersection scenarios with moderate vehicle speeds (1-3 m/s) and standard projector configurations (4.6-5.2 m projection distance, or 15-17 ft), this advantage ranges from 1.5 to 3 seconds. In scenarios with severe corner occlusion where line-of-sight detection occurs very late, combined with longer projection distances and favorable geometry, the advantage can extend to 3-4 seconds. This advance notice enables the autonomous robot (12) to smoothly decelerate, compute alternative paths, or take other proactive collision avoidance measures, rather than requiring emergency braking or sudden maneuvers.

### II. Alternative Embodiments and Variations

### A. Multi-Modal Pattern Detection

While the primary embodiments described above focus on visual detection of projected patterns using cameras, alternative embodiments may employ additional sensing modalities:

### A.1 Polarization-Based Detection

Projected light patterns often exhibit polarization characteristics different from ambient lighting. A camera sensor equipped with a polarization filter array (PFA) can detect these polarization differences, enabling improved discrimination.

### A.2 Spectral Detection

Many safety projectors employ LEDs with narrow spectral emission bands. A multispectral or hyperspectral camera sensitive to narrow wavelength bands can detect these spectral signatures.

### A.3 Temporal Modulation Detection

Some safety projectors emit light with temporal modulation (flashing). High-framerate cameras (120 fps or greater) can detect this temporal modulation as a distinctive feature.

### B. Pattern-Type-Specific Processing

Different pattern types may benefit from specialized processing techniques optimized for their geometric and photometric properties.

C. Integration with Existing Perception Systems

### C.1 Sensor Fusion

In preferred embodiments, detections from pattern recognition subsystem (30) are fused with detections from conventional obstacle detection sensors using multi-hypothesis tracking or Joint Probabilistic Data Association (JPDA) algorithms.

### C.2 Map-Based Filtering

When the autonomous mobile robot (12) has access to the facility map, pattern detections can be filtered based on map consistency. Patterns detected inside storage racks (where vehicles cannot travel) are marked as false positives.

### C.3 Fleet Coordination

In multi-robot deployments, pattern-based vehicle detections can be shared among fleet members via wireless communication, enabling robots to prime their detection systems and adjust path planning based on shared information.

### D. Adaptive Processing

### D.1 Lighting-Adaptive Processing

Pattern recognition subsystem (30) adapts processing parameters based on ambient lighting conditions detected by ambient light sensors.

### D.2 Surface-Adaptive Processing

Different ground surface types affect projected pattern appearance. Pattern recognition subsystem (30) may detect surface type and adapt processing accordingly.

### E. Hardware Implementation Variations

### E.1 Computing Platform Options

Pattern recognition subsystem (30) and vehicle localization subsystem (40) may be implemented on various hardware platforms: —General Purpose CPU (Intel Core i5/i7, AIMD Ryzen)—suitable for rule-based or traditional ML —GPU-Accelerated Processing (NVIDIA GPUs with CUDA)—enables real-time deep learning inference at 30+ fps —Edge AI Accelerators (Google Coral TPU, Intel Movidius VPU, NVIDIA Jetson)—optimized neural network inference at reduced power (5-30 watts) —FPGA Implementation—for high-volume deployments, very low latency and power

### E.2 Camera Implementation Options

Visible Light Cameras (RGB)—most common and cost-effective
Near-IR Cameras (750-900 nm sensitivity)—beneficial in variable lighting
Thermal Cameras—detect thermal signatures from projected patterns

### F. Pattern Library and Learning

### F.1 Online Learning

The pattern recognition subsystem (30) incorporates online learning capabilities. When detecting a pattern with moderate confidence (60-80%), detection and image patch are stored for review. Human operator or automated validation provides ground truth labels. Labeled examples are added to the training dataset for periodic retraining.

### F.2 Pattern Library Management

In facilities with a known fleet, a pattern library catalogs specific projector patterns used by each vehicle, enabling vehicle identification and improved position estimation using vehicle-specific mounting positions.

### III. Method Embodiments

In accordance with method embodiments, FIG. 3A illustrates a process for collision avoidance using safety projector pattern detection.

### Step 100: Image Capture

Continuous acquisition of sensor data from ground-facing sensor array (20). Camera array (22) captures images at specified frame rate (e.g., 30 fps), and LIDAR sensor (24) captures point cloud data at specified scan rate (e.g., 10 Hz).

### Step 105: Ground Surface Detection

Three-dimensional point cloud data from LIDAR sensor (24) is processed to identify ground surface points using modified RANSAC plane fitting with specific parameters (d_thresh=0.05 m, K=100 iterations, h_max=0.3 m).

### Step 107: Camera-LIDAR Projection and Mask Generation

Identified ground surface points are projected onto camera image planes using calibrated transformation parameters T_CL. Binary masks M(u, v) are generated marking ground surface regions as valid search regions (M=1) and non-ground regions as excluded (M=0).

### Step 108: Iterative Mask Refinement

The system performs iterative refinement of ground surface masks: 1. Apply pattern detection to current masked regions 2. Validate detected patterns using LIDAR height variance 3. Expand mask locally for confirmed patterns (morphological dilation) 4. Contract mask locally for rejected patterns (morphological erosion) 5. Repeat for up to 3 iterations or until convergence

### Step 110: Pattern Detection

Pattern recognition subsystem (30) processes ground-masked sensor data using GPD-Net architecture. Pattern detection processing is applied only to pixels within masked regions where M(u, v)=1.

Output comprises zero or more pattern detections, each comprising: —Pattern type (spot, arrow, line, arc) —Ground-plane position (x_g, y_g) in metric coordinates —Pattern characteristics (color, size, orientation) —Detection confidence score —Uncertainty estimates (σ²_x, σ²_y)

### Pattern Detected Decision

If no patterns are detected, return to Step 100. If one or more patterns are detected, proceed to Step 120.

### Step 120: Vehicle Localization

For each detected pattern, vehicle localization subsystem (40) estimates: —Position (Xv, Yv) using pattern-to-vehicle offset D and orientation θ —Velocity (Vx, Vy) using Kalman filter tracking across frames —Orientation (θ) from pattern characteristics —Associated uncertainty estimates and covariance matrices

### Trajectory Prediction

Using estimated vehicle state with uncertainty, predict future trajectory over prediction horizon (e.g., 10 seconds). May generate multiple trajectory hypotheses for ambiguous intentions with associated probabilities.

### Step 130: Collision Risk Evaluation

Collision prediction and response subsystem (50) evaluates collision risk by: —Computing Time To Collision (TTC) accounting for uncertainty —Computing Closest Point of Approach (CPA) with confidence intervals —Computing Collision Probability considering trajectory uncertainty —Evaluating state transitions (SAFE/CAUTION/DANGER) using adaptive thresholds

### Collision Anticipated Decision

Based on computed metrics and risk state, determine if collision is anticipated. If no collision is anticipated, return to Step 100. If collision is anticipated, proceed to Step 140.

### Step 140: Response Generation

When collision is anticipated, generate and execute suitable responses: —CAUTION state: Speed reduction (25-50%), increased sensor attention, pre-emptive braking preparation —DANGER state: Emergency speed reduction (50-100%), trajectory modification, emergency stop if needed

Verify actuation via feedback. If actuation fails, escalate to emergency stop. After executing response, return to Step 100 to continue monitoring.

### Method Variations

Alternative method embodiments may include: —Multi-Object Tracking: Associate pattern detections across frames to maintain persistent tracks —Map Integration: Correlate detected positions with facility map to filter inconsistencies —Fleet Communication: Transmit detected vehicle information to fleet management system —Performance Logging: Record events and metrics for offline analysis

### IV. Advantages and Benefits

The disclosed systems and methods provide numerous advantages:

### A. Early Detection

By detecting safety projector patterns before direct vehicle observation, the system provides advance warning (typically 1-3 seconds, up to 3-5 seconds in severe occlusion scenarios) enabling proactive collision avoidance.

### B. Non-Line-of-Sight Capability

Projected patterns can be visible when an emitting vehicle is occluded, enabling detection in blind intersection scenarios.

### C. Leverages Existing Infrastructure

Utilizes existing safety projector infrastructure already widely deployed, avoiding the need to retrofit vehicles.

### D. Mixed Fleet Compatibility

Functions in mixed autonomous-human vehicle environments, detecting both human-operated and autonomous vehicles with safety projectors.

### E. Complementary to Existing Systems

Provides additional detection modality that improves overall system robustness and reliability.

### F. Cost Effectiveness

Camera-based pattern detection can be implemented at modest cost ($500-2000 per vehicle).

### G. Scalability

Scales naturally to large facilities as each vehicle independently detects any other vehicle with projectors.

### H. Improved Efficiency Through LIDAR-Based Ground Masking

LIDAR ground surface detection and iterative mask refinement provides: 1. Reduced False Positives: 40-70% reduction by excluding non-ground regions 2. Enhanced Computational Efficiency: 40-70% reduction in processing load 3. Improved Detection Accuracy: Higher signal-to-noise ratio

### V. Safety Analysis and Standards Compliance

### A. Functional Safety Requirements

The collision avoidance system is intended for safety-critical applications where failure to detect approaching vehicles could result in collision, injury, or equipment damage. The system is meets functional safety requirements per IEC 61508 and ISO 3691-4.

### A.1 Safety Integrity Level

The system targets Safety Integrity Level 2 (SIL 2) per IEC 61508, corresponding to probability of failure on demand (PFD) in range of 10⁻³ to 10⁻². This SIL rating is suitable for autonomous mobile robot collision avoidance where: —Consequences of failure: Injury or considerable equipment damage (Severity Class II) —Frequency of exposure: Continuous during operation —Avoidability: Limited in blind intersection scenarios

SIL 2 achievement requires systematic analysis of hardware reliability, software development processes per IEC 61508-3, and validation that overall system dangerous failure rate meets 10⁻³ to 10⁻² target.

### A.2 Hazard and Risk Analysis

A Failure Mode and Effects Analysis (FMEA) identifies potential failure modes and mitigations:
Pattern Detection False Negative (Failure to Detect): —Cause: Degraded lighting, pattern occlusion, algorithm failure —Effect: No early warning; reliance on line-of-sight detection —Mitigation: Sensor fusion with line-of-sight LIDAR/camera; adaptive threshold adjustment; confidence scoring
Vehicle Localization Error: —Cause: Incorrect pattern-to-vehicle offset, calibration drift —Effect: Inaccurate collision prediction —Mitigation: Uncertainty bounds on position estimates; Kalman filter covariance; periodic recalibration
Sensor Hardware Failure: —Cause: Camera malfunction, LIDAR failure, lens contamination —Effect: Loss of detection capability —Mitigation: Sensor health monitoring with ≥90% diagnostic coverage; automatic safe state transition; redundancy through sensor fusion
Processing System Failure: —Cause: Software crash, hardware fault —Effect: Complete loss of collision avoidance —Mitigation: Watchdog timer (timeout 500 ms); automatic safe state transition; fail-safe controller independent of main processor
Actuation Failure: —Cause: Motor controller fault, brake actuator malfunction —Effect: Collision despite correct detection —Mitigation: Brake actuation confirmation feedback; escalation to emergency stop if not confirmed; periodic brake testing

FMEA analysis indicates that with implemented mitigations, the system achieves Safe Failure Fraction (SFF)≥90% and Hardware Fault Tolerance (HFT)=0, acceptable for SIL 2 per IEC 61508-2 Table 2.

### A.3 ISO 3691-4 Compliance

ISO 3691-4 establishes safety requirements for driverless industrial trucks. Key compliance aspects:
Obstacle Detection Range (ISO 3691-4 Section 5.8.2): —Requirement: Detection range≥braking distance+safety margin —Compliance: Pattern detection range of 5-15 meters exceeds required braking distance of 2-4 meters at typical speeds, providing 3-12 meter safety margin
Detection Response Time (ISO 3691-4 Section 5.8.3): —Requirement: <100 ms from obstacle detection to brake activation —Compliance: Total system latency≤500 ms with brake activation within 100 ms of collision risk determination
Protective Fields (ISO 3691-4 Section 5.8.4): —Requirement: Warning field and protective field defined —Compliance: CAUTION state (TTC<10 s or CPA<5 m); DANGER state (TTC<5 s or CPA<2 m)
Environmental Robustness (ISO 3691-4 Section 5.4): —Requirement: Function across expected environmental conditions —Compliance: Validated performance in lighting 100-10,000 lux; wet and dry surfaces; temperature 0-40° C.
Fail-Safe Behavior (ISO 3691-4 Section 5.7): —Requirement: Vehicle stops if safety function fails —Compliance: Watchdog timer and sensor diagnostics trigger safe state (stop+manual restart) upon fault

### B. Operational Limitations and Conditions

To maintain safety performance, system requires:
Maximum Operating Speed: 2.0 m/s in areas relying on pattern-based detection
Minimum Projector Visibility: Safety projectors must emit ≥200 lumens at wavelengths 450-650 nm
Environmental Conditions: Operational in ambient light 100-10,000 lux; performance may degrade in direct sunlight >15,000 lux requiring speed reduction
Ground Surface: Functional on concrete, asphalt, painted surfaces; performance may vary on highly reflective or highly absorptive surfaces
Fleet Compatibility: Assumes ≥90% of industrial vehicles equipped with safety projectors; system remains dependent on line-of-sight detection for non-equipped vehicles

### Other Implementation Options

It should be understood that the example embodiments described above may be implemented in many different ways. In some instances, the various “data processors” may each be implemented by a physical or virtual general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system. One or more central processor units are attached to the system bus and provide for the execution of computer instructions. Also attached to system bus are typically I/O device interfaces for connecting disks, memories, and various input and output devices. Network interface(s) allow connections to various other devices. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

The above description contains several example embodiments. It should be understood that while a particular feature may have been disclosed with respect to only one of several embodiments, that particular feature may be combined with one or more other features of the other embodiments as may be desired and advantageous for any given or particular application. It is, of course, not possible to describe every conceivable combination of components or methodologies for purposes of describing the innovations herein, and one skill in the art may now, in light of the above description, recognize that many further combinations and permutations are possible. Also, to the extent that the terms “includes,” and “including” and variants thereof are used in either the detailed description or the claims, these terms are intended to be inclusive in a manner similar to the term “comprising”.

It also should be understood that the block and flow diagrams may include more or fewer elements, be arranged differently, or be represented differently. The computing devices, processors, controllers, firmware, software, routines, or instructions as described herein may also perform only certain selected actions and/or functions. Therefore, it will be appreciated that any such descriptions that designate one or more such components as providing only certain functions are merely for convenience.

When a series of steps has been described above with respect to the flow diagrams, the order of the steps may be modified in other implementations. In addition, the operations and steps may be performed by additional or other modules or entities, which may be combined or separated to form other modules or entities. For example, while a series of steps has been described with regard to certain figures, the order of the steps may be modified in other implementations consistent with the principles explained herein.

Further, non-dependent steps may be performed in parallel. Further, disclosed implementations may not be limited to any specific combination of hardware.

No element, act, or instruction used herein should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

Accordingly, the subject matter covered by this patent is intended to embrace all such alterations, modifications, equivalents, and variations that fall within the spirit and scope of the claims that follow.

1. A collision avoidance system for an autonomous mobile robot operating in an environment with industrial vehicles equipped with safety projector systems, comprising:
a sensor array mounted on said autonomous mobile robot and configured to monitor a region that includes a ground surface for projected light patterns, said sensor array comprising at least one camera oriented to capture images of said region;
a pattern recognition module comprising a processor and non-transitory computer-readable memory storing instructions that, when executed by said processor, cause said processor to: receive image data from said at least one camera; process said image data to detect projected light patterns on said ground surface, said projected light patterns comprising safety projector patterns emitted by industrial vehicles; and distinguish said safety projector patterns from non-pattern ground markings;
a vehicle localization module configured to estimate a position of an industrial vehicle based on a detected safety projector pattern, wherein said estimated position is computed based on a position of said detected safety projector pattern and a known spatial offset between a safety projector and a body of said industrial vehicle; and
a collision prediction module configured to: predict a trajectory of said industrial vehicle based on said estimated position; evaluate a collision risk between said industrial vehicle and said autonomous mobile robot based on said predicted trajectory; and generate a collision avoidance response when said collision risk exceeds a predetermined threshold.

2. The collision avoidance system of claim 1, wherein said sensor array comprises a plurality of cameras directed toward said ground surface and positioned to provide 360-degree coverage of said ground surface around said autonomous mobile robot.

3. The collision avoidance system of claim 1, wherein said sensor array further comprises:
a LIDAR sensor configured to capture three-dimensional spatial data of said ground surface; and
wherein said vehicle localization module is configured to determine a distance to said detected safety projector pattern based on said three-dimensional spatial data from said LIDAR sensor.

4. The collision avoidance system of claim 3, wherein said vehicle localization module is further configured to:
process three-dimensional spatial data from said LIDAR sensor to identify ground surface regions;
filter pattern detection operations to focus on said identified ground surface regions while excluding non-ground regions; and
refine said ground surface regions iteratively based on validation of detected patterns against three-dimensional geometry;
wherein said filtering reduces false positive detections and improves computational efficiency.

5. The collision avoidance system of claim 1, wherein said pattern recognition module is configured to distinguish between different types of safety projector patterns and infer a type of said industrial vehicle or an operational state of said industrial vehicle based on characteristics of said detected safety projector pattern.

6. The collision avoidance system of claim 1, wherein said collision prediction module is further configured to determine an intended direction of travel of said industrial vehicle based on orientation or movement characteristics of said detected safety projector pattern.

7. The collision avoidance system of claim 1, wherein said pattern recognition module comprises a neural network configured to:
extract features from said image data that are adapted to perspective distortion of ground-projected patterns;
aggregate information across multiple sequential frames to enable detection of partially visible patterns; and
output pattern locations with associated confidence estimates;
wherein said neural network is trained to detect safety projector patterns under varying perspective views and partial occlusion conditions.

8. The collision avoidance system of claim 7, wherein said neural network is trained using:
data augmentation simulating variations in ground surface materials, camera perspectives, motion blur, and partial pattern visibility;
training samples progressively increasing in difficulty; and
techniques enabling adaptation to new pattern types with limited labeled data;
wherein robustness to real-world deployment conditions is improved.

9. The collision avoidance system of claim 7, wherein said neural network extracts features comprising:
intensity distribution characteristics of projected light patterns;
color characteristics distinguishing LED-based projectors from painted markings; and
geometric consistency characteristics of ground-projected patterns;
wherein said features enable discrimination between safety projector patterns and other ground markings.

10. The collision avoidance system of claim 7, wherein said neural network is configured to:
predict, for each detected pattern, both a pattern location and a confidence measure quantifying uncertainty in said location;
train said confidence measures to correlate with actual detection accuracy; and
use said confidence measures to reduce false indications by triggering collision avoidance responses only when confidence exceeds a reliability threshold.

11. The collision avoidance system of claim 1, wherein said vehicle localization module is further configured to:
track said detected safety projector pattern across multiple successive image frames;
estimate a velocity of said industrial vehicle based on movement of said detected pattern across said frames; and
compute uncertainty bounds for said estimated position and velocity;
wherein said predicted trajectory incorporates said velocity estimate and said uncertainty bounds.

12. The collision avoidance system of claim 1, wherein said collision prediction module is configured to:
compute a time-to-collision (TTC) metric indicating an estimated time until collision between said industrial vehicle and said autonomous mobile robot if both vehicles maintain current trajectories;
incorporate uncertainty bounds from position and velocity estimates into said TTC computation to generate probabilistic time-to-collision wherein said collision risk exceeds said predetermined threshold when probability of collision within said TTC exceeds a threshold probability; and
wherein said collision risk exceeds said predetermined threshold when said TTC is less than a threshold time value adaptively adjusted based on vehicle velocity and position uncertainty.

13. The collision avoidance system of claim 1, wherein said collision prediction module is configured to:
compute a closest point of approach (CPA) metric indicating a minimum distance between said industrial vehicle and said autonomous mobile robot along predicted trajectories;
compute effective CPA as CPA_effective=CPA_nominal+3·σ_total where σ_total represents combined uncertainty from position estimation, velocity estimation, and trajectory prediction; and
wherein said collision risk exceeds said predetermined threshold when said CPA_effective is less than a threshold distance value.

14. The collision avoidance system of claim 1, wherein said collision prediction module implements a state machine comprising a plurality of risk states including a SAFE state, a CAUTION state, and a DANGER state, and further where:
in said SAFE state, no collision avoidance response is generated;
in said CAUTION state, said collision avoidance response comprises reducing a speed of said autonomous mobile robot moderately and increasing sensor frame rates;
in said DANGER state, said collision avoidance response comprises at least one of: reducing said speed of said autonomous mobile robot to a low speed, bringing said autonomous mobile robot to a complete stop, or modifying a planned trajectory; and
wherein state transitions incorporate uncertainty-based threshold adjustment wherein higher position and velocity uncertainty triggers earlier transitions to CAUTION and DANGER states.

15. The collision avoidance system of claim 1, further comprising:
a watchdog timer module configured to monitor responsiveness of said pattern recognition module and said vehicle localization module; and
a fail-safe controller configured to: —detect a non-responsive state when said watchdog timer expires without reset; —transition said autonomous mobile robot to a safe state comprising at least one of: emergency stop, speed reduction to minimum velocity, or activation of audible warning; and —require manual operator intervention to exit said safe state.

16. The collision avoidance system of claim 3, further comprising:
a sensor diagnostic module configured to: —perform periodic self-tests of said LIDAR sensor and said at least one camera including signal quality assessment and optical path verification; —detect sensor degradation including lens contamination, laser power reduction, or sensor misalignment; —generate a fault indication when sensor performance falls below a predetermined quality threshold; and —disable pattern-based collision avoidance and revert to line-of-sight obstacle detection only when sensor fault is detected.

17. The collision avoidance system of claim 1, wherein said system achieves Safety Integrity Level 2 (SIL 2) per IEC 61508, comprising:
safety-related architecture with redundancy and fault detection mechanisms;
documented safety requirements specification, hazard analysis, and validation evidence; and
systematic development processes meeting SIL 2 capability requirements.

18. The collision avoidance system of claim 1, wherein said system complies with ISO 3691-4 safety requirements for driverless industrial trucks, comprising:
obstacle detection range exceeding required braking distance at maximum operating speed;
system response time from pattern detection to brake actuation enabling safe vehicle stop; and
fail-safe behavior comprising transition to a safe stopped state upon detection of sensor or processing subsystem faults.

19. The collision avoidance system of claim 1, wherein:
said pattern recognition module detects projected light patterns by monitoring ground surfaces rather than directly detecting vehicles through line-of-sight observation; and
said detection enables identification of approaching vehicles before said vehicles are visible through line-of-sight detection.

20. The collision avoidance system of claim 1, wherein:
said vehicle localization module estimates vehicle position indirectly from detected projected patterns on ground surfaces rather than directly from vehicle body detection;
wherein said indirect localization enables early warning of approaching vehicles around corners or behind obstacles.

21. The collision avoidance system of claim 3, wherein:
said vehicle localization module validates detected patterns against three-dimensional geometric data from said LIDAR sensor to distinguish true ground-projected patterns from false detections;
wherein said validation reduces false positive detections.

22. A method for collision avoidance in an autonomous mobile robot operating in an environment with industrial vehicles equipped with safety projector systems, comprising:
capturing, using a ground-facing camera mounted on said autonomous mobile robot, images of a ground surface in a vicinity of said autonomous mobile robot;
processing said images to detect projected light patterns on said ground surface, wherein said processing comprises distinguishing safety projector patterns emitted by industrial vehicles from non-pattern ground markings;
for each detected safety projector pattern: estimating a position of an industrial vehicle emitting said detected safety projector pattern, wherein said estimated position is computed based on a position of said detected safety projector pattern on said ground surface and a spatial offset between safety projectors and vehicle bodies, predicting a trajectory of said industrial vehicle based on said estimated position, and evaluating a collision risk between said industrial vehicle and said autonomous mobile robot based on said predicted trajectory; and
when said collision risk exceeds a predetermined threshold, generating a collision avoidance response.

23. The method of claim 22, further comprising:
capturing, using a LIDAR sensor, three-dimensional spatial data of said ground surface;
processing said three-dimensional spatial data to identify ground surface points using a plane-fitting algorithm with distance and height threshold parameters;
projecting said identified ground surface points onto image planes of said camera to generate binary masks marking ground surface regions as valid search regions;
iteratively refining said binary masks based on pattern detection results by validating detected patterns using LIDAR height variance, expanding masks for confirmed patterns, contracting masks for rejected patterns, and repeating for multiple iterations; and
focusing said processing of said images on ground surface regions marked in said binary masks while excluding non-ground regions, thereby reducing false positive detections and improving computational efficiency.
